(19) United States
(12) Patent Application Publication
(10) Pub. No.: US 2026/0312929 A1
(43) Pub. Date: Oct. 8, 2026

(54) DYNAMIC NOTIFICATION PRIORITY IN MESSAGING SYSTEM

(71) Applicant: Abraham Z. Swiller, Los Angeles, CA (US)

(72) Inventor: Abraham Z. Swiller, Los Angeles, CA (US)

(21) Appl. No.: 19/639,429

(22) Filed: Apr. 6, 2026

Related U.S. Application Data
(60) Provisional application No. 63/834,601, filed on Apr. 7, 2025.
(60) Provisional application No. 63/835,443, filed on Jun. 23, 2025.
(60) Provisional application No. 63/835,621, filed on Jul. 7, 2025.

(51) Int. Cl. H04L 51/224

(52) U.S. Cl. CPC H04L 51/224

(57) ABSTRACT

A method includes transmitting, by or on behalf of a first user of a messaging system, via a messaging system included on one or more processing devices, a message addressed to a second user of the messaging system, determining a response status of a response message, the response status indicating receipt or non-receipt of the response message via the messaging system; setting a notification priority based, at least in part, on the response status, wherein a first response status associated with non-receipt of the response message is assigned a first notification priority, and a second response status associated with receipt of the response message is assigned a second notification priority as indicated by information included in the response message; and activating a notification to the first user via the messaging system based on the notification priority.

### CROSS-REFERENCE TO RELATED APPLICATIONS

This application claims priority pursuant to 35 U.S.C. § 119(e) to the following U.S. Provisional Applications: U.S. Provisional Application No. 63/834,601 entitled “System and Method for Mutual Call Scheduling and Escalation for Safety Monitoring,” filed Apr. 7, 2025; U.S. Provisional Application No. 63/835,443, entitled “Multi-Party Safety Check-In and Notification System with Optional Location Tracking,” filed Jun. 23, 2025; and U.S. Provisional Application No. 63/835,621, entitled “System and Method for Scheduled Safety Check-Ins Between Trusted Individuals,” filed Jul. 7, 2025; all of which are incorporated herein in their entirety for all purposes.

### STATEMENT REGARDING FEDERALLY SPONSORED RESEARCH OR DEVELOPMENT

Not Applicable.

### BACKGROUND OF THE INVENTION

### Technical Field of the Invention

This invention relates generally to messaging systems, and more particularly to messaging systems implementing notification priority.

### Description of Related Art

Communications and messaging systems are used by various social media platforms, productivity and business applications. Various systems facilitate rapid communication through text, media, or data exchange, ranging from direct person-to-person apps to backend message brokers for distributed systems. Some of these messaging systems may employ various types of email, such as Internet message access protocol (IMAP), post office protocol (POP), simple mail transfer protocol (SMTP), Microsoft Exchange, or the like. Other messaging systems may use short messaging services (SMS), multimedia messaging services (MMS), rich communication services (RCS), or the like. Some messaging systems may also provide for instant messaging (IM), in-app messages, and/or push notifications. Still others may be used to provide encrypted messaging services. Some messaging systems require dedicated graphical user interfaces (GUIs) for communication and messaging.

Many messaging services provide a notification when a message is received. The messages may be original messages initiated by a sender, or they may be replies to message transmitted earlier. Some original messages and replies may include a priority indicator. For example when an email is received, an exclamation mark may be displayed in the email recipients in-box if the sender of the message marks the email as a high priority. Additionally, some smart devices allow a person to specify different notification sounds based on the originator of the message. For example, different ring tones may be specified for different callers included in the recipients contacts.

### BRIEF DESCRIPTION OF THE SEVERAL VIEWS OF THE DRAWING(S)

FIG. 1 is a block diagram illustrating a messaging system in accordance with example embodiments;

FIG. 2 is an information flow diagram illustrating message flow within a messaging system, in accordance with various example embodiments;

FIG. 3 is an alternative information flow diagram illustrating an alternative message flow within a messaging system, in accordance with various example embodiments;

FIG. 4A is a flowchart illustrating a messaging method implementing recipient scheduling permissions, in accordance with various example embodiments;

FIG. 4B is a flowchart illustrating a messaging method implementing recipient AI permissions, in accordance with various example embodiments;

FIG. 5 is a flowchart illustrating a messaging method implementing dynamic notification priority, in accordance with various example embodiments;

FIG. 6 is a flowchart illustrating a method of generating and delivering messages, in accordance with various example embodiments;

FIG. 7 is a flowchart illustrating a method of generating and delivering notifications, in accordance with various example embodiments;

FIG. 8 is a diagram illustrating a recipient user interface, in accordance with various example embodiments;

FIG. 9A is a diagram illustrating a sending-user interface in a communications mode, in accordance with various example embodiments;

FIG. 9B is a diagram illustrating a sending-user interface in an instruction mode, in accordance with various example embodiments;

FIG. 10 is a diagram illustrating a notification screen of a sending-user interface, in accordance with various example embodiments; and

FIG. 11 is a block diagram of a processing device, in accordance with various example embodiments.

### DETAILED DESCRIPTION OF THE INVENTION

A messaging system according to various example embodiments allows a notification priority to be assigned dynamically. As used herein, unless otherwise required by context, the term “notification priority” refers to a “dynamic notification priority.” In one or more example embodiments, a notification priority may be used to control whether a message response notification provided to a sender of the message that provoked the response is disruptive or non-disruptive, how quickly the notification is delivered, the number and/or type of channel by which the notification is provided, a repetitiveness of the notification, a number of people notified, or some combination of notification characteristics. Although the discussion herein may refer to receiving a response to a message, for purposes of notification, non-receipt of a message within a given amount of time also triggers a notification. Thus, either receipt of a message or non-receipt of a message may trigger a message response notification.

As used herein, the term “mandatory response” or “mandatory response protocol” refers to using either an affirmative receipt of response message sent by a message recipient or non-receipt of a response message from the message recipient to trigger a message response notification. The term, “mandatory response” should not be interpreted to include forcing a recipient is forced to affirmatively respond to a message under a threat of penalty.

In various example embodiments, the notification priority is determined dynamically, at the time of receipt, or non-receipt, of a response from a message recipient. It may be important to distinguish between a message priority included, attached, or associated with a message or a response to that message, and a notification priority. For example, while a high message priority or a high response-message priority may be associated with an original message or a response to the original message, a notification priority according to various example embodiments discussed herein may not be assigned a notification priority associated with a response to a message may be different from the message priority of a response. In fact, the notification priority is, in various example embodiments, not yet known at the time the message or response are sent. Instead the notification priority is dynamically determined during the communication process.

Some example embodiments also include a “durable consent” process, in which a message recipient agrees to allow a series of messages from a sender to be delivered at future times, for example on a schedule. In some implementations, a message recipient may request or consent to allowing an artificial intelligence (AI) agent to act on behalf of a human message sender. Note that in some example embodiments, notifications may be sent to the human sender on behalf of whom the AI agent is acting. In those cases, even though an AI agent may create and/or transmit the messages, a human may receive all or some of the response notifications in accordance with a dynamically determined notification priority.

In various example embodiments, the notification priority may be determined based on a response status associated with a sent message, on the contents of a response to the sent message, or the like. The contents of the message may include explicitly selected urgency information, or text, images, audio, etc. that may be analyzed to determine a notification priority.

One or more example embodiments may be implemented as a method including: transmitting, by or on behalf of a first user of a messaging system, via a messaging system including on one or more processing devices, a message addressed to a second user of the messaging system; determining a response status of the message, the response status indicating receipt or non-receipt of a response message via the messaging system; setting a notification priority based, at least in part, on the response status, wherein a first response status associated with non-receipt of the response message is assigned a first notification priority, and a second response status associated with receipt of the response message is assigned a second notification priority as indicated by information included in the response message; and activating a notification to the first user via the messaging system based on the notification priority.

Example embodiments of the method further include scheduling, by the first user, automated transmission of one or more messages to the second user at one or more future times; providing the second user with a schedule indicating when the one or more messages are scheduled to be transmitted; and automatically transmitting, by the messaging system, the one or more messages in accordance with the schedule.

Other example embodiments include opening, by the messaging system, a response window, the response window defining a period for the second user to transmit the response message. Some example embodiments also include, in response to non-receipt of the response message by the messaging system before expiration of the response window, the messaging system sets the first notification priority to high.

Example embodiments of the method may also include, in response to the messaging system receiving the response message before expiration of the response window, the messaging system sets the second notification priority to a value determined by the information included in the response message.

In some example embodiments of the method, activating the notification to the first user includes one or more of: triggering an immediate notification to the first user; triggering a real-time interruption notification to the first user; transmitting a text message to the first user; transmitting an external social media platform notification to the first user; changing a visual status indicator within the messaging system; updating a data structure to include a last contact date associated with the second user; or triggering an audible, visual, or tactile notification on a mobile computing device of the first user.

Some example embodiments of the method also include presenting, to the first user via a graphical user interface (GUI), an option to respond to the notification by switching to an external communication channel.

Other example embodiments include receiving, from the second user, second-user input authorizing the first user to transmit and schedule future message transmissions via the messaging system; and transmitting the message from the first user to the second user in accordance with the second-user input. The second notification priority, as indicated by the information included in the response message, may include second-user input specifying a level of urgency.

Example embodiments also include, receiving, from a second user, third-user input revoking permission to schedule the future message transmissions via the messaging system.

In other example embodiments, the method includes receiving, from the second user, fourth-user input granting permission to use AI for messaging interactions. Embodiments may also include receiving, from the second user, fifth-user input revoking permission to use AI for the messaging interactions.

In some example embodiments, the messaging system creates an auditable record of communications between the first user and the second user, including response messages assigned priority levels above a given threshold.

Other example embodiments may be implemented as a messaging system including: a first program of instructions configured to provide a first-user interface to the messaging system, the first program of instructions configured to be executed on a first endpoint computing device; and a second program of instructions configured to provide a second user interface to the messaging system, the first program of instructions configured to be executed on a second endpoint computing device; the first program of instructions further configured to: receive, via the first-user interface, transmission instructions associated with transmitting a message to the second user interface; determine a response status of the message, the response status indicating at least one of non-receipt of a response message originating from the second user interface or receipt of the response message originating from the second user interface; set a notification priority based at least in part on the response status, wherein a first response status is associated with the non-receipt of the response message, and is assigned a first notification priority, and a second response status associated with the receipt of the response message is assigned a second notification priority as indicated by information included in the response message; and activate a notification based on the notification priority.

In some such example embodiments, a message server including a processor and associated memory, the message server communicatively coupled to the first endpoint computing device and the second endpoint computing device; and the message server configured to: receive the transmission instructions from the first-user interface, and transmit the message to the second endpoint computing device in accordance with the transmission instructions. The transmission instructions may include scheduling information associated with future transmission of one or more additional messages, and content identification information associated with each of the one or more additional messages.

In some example embodiments, the second program of instructions is further configured to: receive at least one message transmitted to the second endpoint computing device in accordance with the transmission instructions; display the at least one message on the second endpoint computing device; receive user input specifying urgency information to be included in a particular response message associated with the at least one message; and generate the particular response message to include the urgency information.

Some such messaging systems are further configured to: log messages transmitted to the second endpoint computing device by, or on behalf of, the first endpoint computing device; and log response statuses associated with the messages transmitted to the second endpoint computing device by, or on behalf of, the first endpoint computing device.

In some example embodiments, the transmission instructions include at least one of an instance of the message or content identification information associated with the message, the content identification information including a message template identifier. The first program of instructions and the second program of instructions may be differently configured instances of a same program of instructions.

In some example embodiments, the first program of instructions is further configured to transmit the message to the second user interface in accordance with the transmission instructions, and/or open a response window, the response window defining a period during which a response message is anticipated.

In some example embodiments, the first program of instructions is further configured to: activate an interruptive notification on the first endpoint computing device in response to non-receipt of the response message before expiration of the response window; and activate one of an interruptive or a non-interruptive notification in response to receipt of the response message before expiration of the response window.

Other example embodiments, are implemented as an endpoint computing device including: memory storing a program of instructions; a processor coupled to the memory, the processor configured to execute the program of instructions to cause the computing endpoint device to: generate a graphical user interface (GUI) of a messaging system; receive from a first endpoint user of the messaging system, via the GUI, instructions to transmit one or more messages to a second endpoint user according to a schedule; determine whether a response message associated with a first message has been received before expiration of a first response window; and assign a notification priority associated with the first message based, at least in part on, whether the response message associated with the first message has been received before expiration of the first response window, wherein the notification priority is set to an elevated priority level is assigned in response to non-receipt of a response message before expiration of the first response window, and the notification priority is set to a variable priority level indicated by information included in the response message in response to receiving the response message within the first response window; and initiate one of a plurality of different types of notifications to the first endpoint user based on the notification priority.

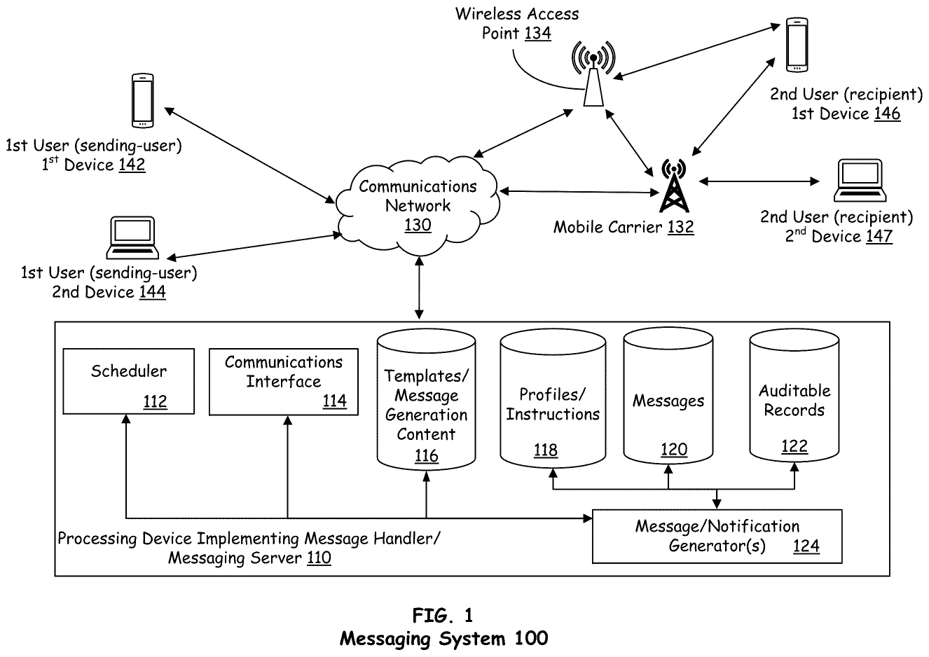

Referring first to FIG. 1, a messaging system 100 will be discussed in accordance with example embodiments. The messaging system 100 includes a message handler 110, which further includes a scheduler 112, a communications interface 114, a template/content datastore 116, a profile/instruction datastore 118, a message datastore 120, an auditable records datastore 122, and a message/notification generator 124. The messaging system 100 also includes the sending-user's first device 142 and the sending-user's second device 144 coupled to the message handler 110 via a communications network 130. The messaging system 100 further includes one or more recipient devices, for example recipient 1^{st} device 146 or recipient 2^{nd} device 147, either or both of which are coupled to the message handler 110 via communications network 130 through either or both a wireless access point (WAP) 134, or a mobile carrier 132.

The messaging system 100 may be implemented in one or more processing devices, for example a server device executing classical, rules-based/deterministic software, an agentic or non-agentic artificial intelligence (AI) system employing Artificial Narrow Intelligence (ANI) or Artificial General Intelligence (AGI), a reactive AI system, a Limited Memory AI system, a generative AI system employing a Large Language Model (LLM), AI systems employing machine learning, deep learning, predictive modeling, or some combination of AI techniques and classical software.

For example, various example embodiments may be implemented using a sequence of deterministic computer executable instructions, while other embodiments may be implemented using a pre-trained LLM adapted to perform one or more specific tasks by further training the LLM using one or more task-specific datasets. In some example embodiments, a commercially available LLM may be adapted through additional training to identify an urgency level within a response message based on language patterns, visual cues, timing, content inclusion/exclusion patterns, even though no urgency is explicitly expressed in the response. In some example embodiments, deterministic computer executable instructions may be used in combination with a specially adapted LLM. For example, classical programming techniques may be used for keyword detection, while using a specially adapted LLM for more nuanced language and content analysis.

In some example embodiments, a general LLM model may be adapted to function as an agentic AI. The agentic AI may be used to control communications with a recipient in accordance with instructions received from a human message initiator, and in some cases subject to permissions granted by a recipient. In some such example embodiments, routine communications may be generated and transmitted by the agentic AI. Responses to those routine communications may also be evaluated by the Agentic AI, and reported to a message initiator.

It should be noted that the a “message initiator” and a “sending-user” both refer to a human, unless otherwise required by context. However, the term “sender” may refer to a human who actually enters message content and transmits the message, or to a computer program and/or agentic AI that generates a message and transmits that message in accordance with instructions provided by a human.

In various example embodiments, the message handler 110 receives one or more messages, instructions related to message delivery, or both, from a sending-user, and transmits messages to one or more recipient devices 146 on behalf of the sending-user. In some example embodiments, the sending-user transmits a message to the message handler 110, which acts as an intermediary and forwards the message to the intended recipient in accordance with instructions previously stored on the message handler 110. The previously stored instructions for delivering the message may include instructions that cause the message handler to forward the message to the intended recipient based on delivery information included in the message, for example a phone number, an email address, or the like. In some example embodiments, the delivery information may include a messaging system user-name associated with the intended recipient, an account number, an addressee profile identifier, or the like. The message handler 110 may perform a lookup operation to identify one or more delivery addresses associated with the one or more recipient devices 146, and forward the message to the one or more recipient devices 146 identified by the lookup operation.

In other example embodiments, a sending-user may deliver transmission instructions to the message handler 110 in advance of sending messages for delivery to the recipient, at the same time a message is sent for delivery to the recipient. In various example embodiments, these transmission instructions may include message generation instructions, and/or an instance of the message to be transmitted to the recipient. The transmission instructions may direct the message handler 110 to perform a given tasks, in a given way, at a given time. For example, the transmission instructions may include the text of a message to be transmitted, or content identification information such as a content type identifier and/or a message template identifier. In some example embodiments, a message template identifier may be used by the message handler 110 when generating a specific message, and a content type identifier may be used by the message handler 110 to select a particular message template for a given type of message.

The transmission instructions may also include instructions regarding message formatting, a message transmission schedule, a duration of a response window, types of notifications and/or to be used for different notification priorities, destination devices for particular notification notifications, timing for transmitting notifications having particular priorities, or the like.

Messages and instructions received at the message handler 110 from the sending-user, messages transmitted to a message recipient by the message handler 110, responses received at the message handler 110 from the message recipient, any recipient responses the message handler 110 forwards to the sending-user, and any notifications or notifications transmitted by the message handler 110, are received and/or transmitted via the communications interface 114. In various example embodiments, the message handler 110 logs communications to or from the sending-user and the recipient, in addition to actions taken by the message handler 110 in response to those communications. The logs may be stored in the auditable records datastore 122. In some example embodiments, logging the communications and actions taken, allows the accuracy, efficacy, and appropriateness of any messages generated by the message handler 110, as well as the accuracy of any notifications generated by the message handler to be evaluated and used a basis for continuing improvement of the performance of the messaging system 100. In at least some example embodiments, human review and labeling of communications and notifications as to a level of “effectiveness” may be used to further train, and maintain the safety of, any AI models, agents, or the like which may be used in a given implementation.

A messages datastore 120 messages may be used to store instances of messages transmitted to recipients, and responses received from recipients. User profiles for either, or both, sending-users and recipients may be stored in a profiles/instructions datastore 118. In some example embodiments, the profiles/instructions datastore 118 may store instructions related to transmission preferences of the sending-user, including-but not limited to-delivery or transmission schedules; response windows associated with particular messages; message content and/or template identifiers associated with messages to be generated by message handler 110; message identifiers for implementations in which a sending-user submits multiple messages that are stored in messages datastore 120 for later delivery; channels by which one or more messages are to be delivered; notification preferences for particular messages; notification preferences for particular notification priorities; and the like.

In some example embodiments, a templates/message generation content store 116 may be used to store message templates to be used for generating particular types of messages, and message content that a particular sending-user may wish to use for multiple different recipients. In some example embodiments, a send user may request the message handler 110 to generate a message to one or more recipients based on a given template. In some example embodiments, the sending-user may include transmission instructions to the message handler 110 that specifies a particular template identifier, and may also include a recipient identifier. Consider the following example. A sending-user has previously provided instructions, via the sending-user's second device 144, to the message handler 110. The instructions have been stored in the profiles/instructions datastore 118, and specify that message is to be constructed based on a particular message template (not illustrated), and sent to the one or more recipient devices 146 at a particular time on a particular day. In some example embodiments, at the time the instructions are stored, an entry in the scheduler 112 is made, so that at the appropriate time and date, a message/notification generator 124 is activated. In some example embodiments, the scheduler 112 may operate by periodically checking a schedule stored in profiles/instructions datastore 118. Alternatively, or in addition, scheduler 112 may include a schedule datastore (not illustrated) it uses to keep track of scheduled events.

The scheduler 112 activates a message/notification generator 124, which begins a message generation flow, during which it may obtain preference information for the sending-user and the recipient from the profiles/instructions datastore 118, as well as any relevant templates and/or message generation content from a templates/message generation content store 116. The message/notification generator 124 then generates a message in accordance with the profiles, instructions, templates, and content, and transmits the message to the one or more recipient devices 146 via the communications interface 114. The message/notification generator 124 also logs its actions. The log may include, but is not limited to, the time the message was generated, any preferences used, the address to which the message was transmitted, the content of the message, and/or the template used to generate the message. Any exceptions may be reported to one of the sending-user's devices. In one or more example embodiments, the information obtained by message/notification generator 124 may be used as input, for example a prompt, to an LLM that is used to generate the message. In example embodiments employing an LLM, use of a template may not be strictly necessary, although a template may still be used to provide additional constraints on the output of the LLM. In at least one such example embodiment, the constraint provided by using a template improves the likelihood that the LLM will generate a safe, accurate message.

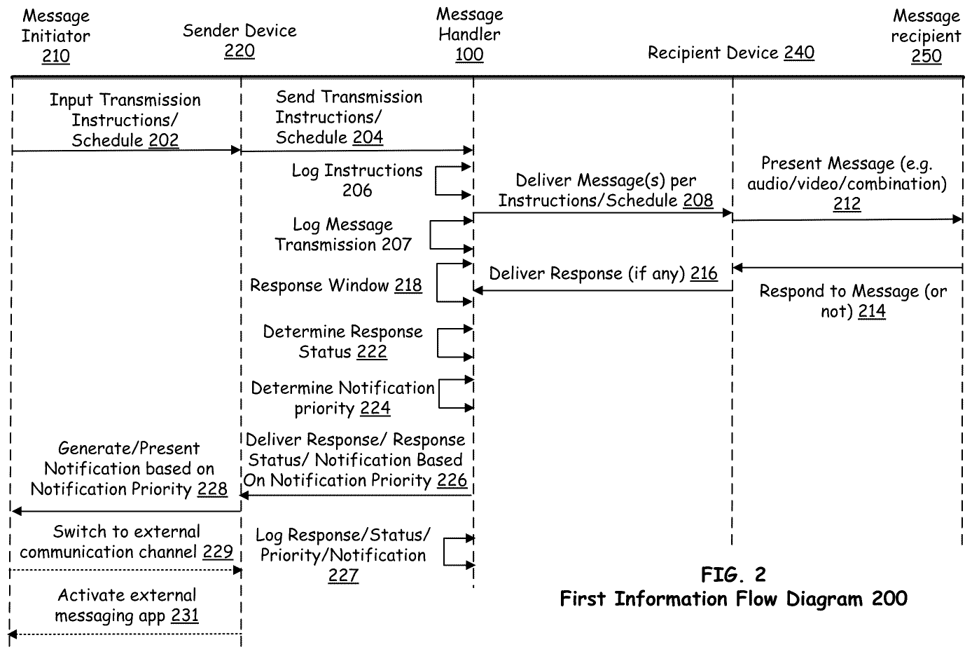

Referring next to FIG. 2, a first information flow diagram 200 illustrating information flow within a messaging system, such as messaging system 100, will be discussed in accordance with various example embodiments. Sequence diagram 200 illustrates information flow between and/or among a message initiator 210, a sender device 220, a message handler 100, a recipient device 240, which may correspond to one or more recipient device(s) 146 (FIG. 1), and a message recipient 250. In an illustrated example embodiment, message initiator 210 performs an input operation 202 during which the message initiator 210 enters transmission instructions and/or scheduling information into the sender device 220. In at least one example embodiment, the input operation 202 includes the sender device 220 executing an instance of a computer executable program or application that displays a graphical user interface configured to accept the transmission instructions and/or scheduling information input by the message initiator 210. The transmission instructions and/or scheduling information are related to the message handler 100 generating, transmitting, and/or forwarding one or more messages to the message recipient 250 on behalf of the message initiator 210. The sender device 220 may perform an instruction/schedule transmission process 204 to send individual instructions input by the message initiator 210 as they are input, or may wait and send multiple instructions packaged as a single message. In various example embodiments, the sending-user's first device 142 (FIG. 1) and the sending-user's second device 144 (FIG. 1), are different instances of the sender device 220.

The message handler 100 may perform a log instructions operation 206 that stores instruction log information in the auditable records datastore 122 (FIG. 1). The instruction log information may include, but is not limited to, any or all of the following: the fact that instructions have been received, one or more time stamps, one or more sender device identifiers, one or more message initiator identifiers, one or more recipient identifiers, one or more recipient device identifiers, one or more instructions or instruction set identifiers, one or more message identifiers, one or more links to other datastores in which the instructions are stored, versioning information, or one or more response window durations associated with one or more messages to be delivered to the message recipient. The log instructions operation 206 may also include storing received instructions in a profiles/instructions datastore 118 (FIG. 1).

The message handler 100 may perform a message delivery operation 208, in which the message handler 100 delivers one or more messages in accordance with the instructions/schedule. In some example embodiments, the message may be generated by message handler 100. In other example embodiments, the message may have been received from the message initiator 210, and forwarded by the message handler 100 either with or without modification of the message contents. In conjunction with, or in response to, the message delivery operation 208, the message handler 100 may perform a log message transmission operation 207, which stores message transmission log information in the auditable records datastore 122 (FIG. 1). The message transmission log information may include may include, but is not limited to, any or all of the following: the fact that a message has been transmitted, one or more time stamps, one or more sender device identifiers, one or more message initiator identifiers, information indicating whether the message is a forwarded message or a message generated by message handler in accordance with received transmission instructions, schedule sequence information indicating the schedule position(s) to which the transmitted message corresponds, one or more recipient identifiers, one or more recipient device identifiers, one or more links to other datastores in which the transmitted message is stored, or versioning information. the log message operation 206 may also include storing an instance of the message in a messages datastore 120 (FIG. 1). Also in conjunction or in response to performing the message delivery operation 208, the message handler 100 may also open a message-handler response window 218. The duration of the response window may correspond to a duration specified by the transmission instructions/schedule input by the message initiator 210, may correspond to a systemwide setting, may correspond to a setting associated with a particular message type, may vary depending on a date and/or time the message handler 100 performs the message delivery operation 208, may correspond to a default setting, or may correspond to a response-window adjustment parameter applied to a default setting based on a profile associated with the message initiator, the message recipient, the type of message, the message delivery channel, or the like.

The recipient device 240 receives the message transmitted by the message handler 100, and performs, in which the message is presented to the message recipient 250 via an instance of a computer executable program or application that displays a graphical user interface (GUI) configured to accept input and present information to the message recipient 250. In one or more example embodiments, the message presentation operation 212 may include displaying a user-selectable object on the GUI indicating that there is an unread message. The message recipient 250 may then activate the user selectable object, for example by clicking, double clicking, hovering, or the like. In response to activating the user selectable object, the recipient device 240 may present the message to the message recipient. In some example embodiments, the message may be a text-based message, a video message, and audio message, or a message including some combination of text, image and/or audio content.

The message recipient 250 may respond to the message, or not, as indicated by recipient response input 214. Note that in the context of the present disclosure, a non-response is considered to be type of response. Consider first the case where the message recipient 250 provides an explicit response (as opposed to an implicit response-e.g. a non-response) to a message initiated by message initiator 210. The response provided by the message recipient may include selection of a user-selectable object, selection of an item from a drop down menu, a textual response, an audio-to-text response, a recorded audio response a recorded video response, mixed media response (some combination of text, audio, images, and/or video), an uploaded file, or the like. The response may include user selected urgency level indicating a subjective urgency level assigned to the response by the message recipient 250. Additionally or alternatively, the message may include implicit indications of urgency reflecting either or both the message recipient's subject evaluation of the urgency, or objective indicators of urgency. The objective indicators of urgency may include certain keywords, understandability of message content, body language (for video responses), speech patterns (for responses including audio), response timing, or the like that may indicate the message recipient's frame of mind, a degradation in the message recipients physical capabilities, or the like.

The recipient device may perform a recipient response delivery operation 216 in instances where the message recipient 250 provides an explicit response. In cases where the message recipient 250 does not input a response to the message, or does not even view the message, the recipient device may not perform the recipient response delivery operation 216. In some example embodiments, not illustrated, the recipient device may start a recipient-side timer, and if the message recipient has not viewed the message or input a response to the message before the expiration of the recipient-side timer, the recipient device 240 may transmit a non-response indication to the message handler 100. However, in at least one example embodiment, the message handler 100 expects to receive either a response input by the message recipient 250, or no-response at all from the recipient device 240. It will be appreciated that network control plane messages and signals are assumed for purposes of this discussion, and should not be considered part of the techniques disclosed herein.

The message handler performs a handler-side response status determination 222, which indicates whether an explicit response from message recipient 250 has been received within the message-handler response window 218. If an explicit response is received within the message-handler response window 218, a response status is set to a value so indicating. If no response is received within the message-handler response window 218, the lack of response is considered an implicit response, and the response status will be set to a value indicating that no timely response has been received. While the response status may affect a notification priority level, the use of a mandatory response protocol may be used to ensure that the message initiator receives a response notification regardless of whether an explicit or implicit response is indicated by the response status.

In some example embodiments the response status may be single bit in a status word, with the bit being set to 1 or 0, depending on whether negative or positive logic is used. The status word (not illustrated) may be maintained in a data store and be used to keep track of any messages. The status word may include one or more bits indicating whether the message handler 100 generated the message, or the message was generated by the message initiator 210 and forwarded by the message handler 100. The status word may also include a waiting-response bit indicating whether a response is still pending for that message, a notification bit indicating whether a notification has been provided to the message initiator, and one or more notification priority bits indicating whether a notification priority has been assigned, and if so, what that notification priority is. Alternative or additional information may be included in the status word, or in another data structure, such as a lookup table. One or multiple suitable data structures may be used to track a status of one or messages or series of messages and responses.

Message handler 100 may perform a handler-side notification priority determination 224 in response to receipt of an explicit response (response received within the message-handler response window 218) or implicit response (no response received within the message-handler response window 218). In at least one example embodiment, in response to an implicit response, the notification priority determination may be set to high, and in response to an explicit response the notification priority is set based on the content of the response. Thus, in various example embodiments, the notification priority may be determined based on one or both of a response status or the contents of a response initiated by the message recipient 250.

In various example embodiments, the message handler 100 performs a response notification process 226, in which response related information is transmitted to the sender device 220 and/or additional devices (not illustrated) as specified by transmission instructions. The response related information may include, but is not limited to, one or more of the following: a copy of the response to the sender device 220, a response status determined by the handler-side response status determination 222, a notification priority as determined by the handler-side notification priority determination 224, or transmitting one or more notifications to the sender device 220, and/or one or more devices. The message handler may perform a notification log process 227 in conjunction with, or in response to, transmitting the response related information. The notification log process may store notification log information, or pointers to the notification log information, in the auditable records datastore 122. The notification log information may include, but is not limited to, any or all of the following: the fact that response related information has been transmitted to one or more devices specified by the message initiator 210 in the transmission instructions, the content of the response related information, the notification priority, the response status, the type of notification provided, one or more time stamps, one or more device identifiers to which a notification has been provided, a channel by which the notification was sent (e.g., email, text, voice call, video call, messaging system notification, tactile notification, screen flash, flashing power indicator), one message and/or response identifiers, one or more message recipient identifiers, one or more message recipient device identifiers, one or more instructions or instruction set identifiers, one or more message identifiers, one or more response window durations, a copy of the original message and a copy of the response, contact and address information of the message recipient, a location of the recipient device 240 (e.g. from a profile stored in profiles/instructions datastore 118, from a GPS or other location reported by the recipient device at the time the response was transmitted from the recipient device (e.g., stored in a message response log), and/or timing information associated with the response.

In some example embodiments, the message handler 100 may include a notification command, which initiates or otherwise causes the sender device 220 to generate and issue a notification determined by the message handler 100. In other example embodiments, the message handler 100 sends information sufficient for the sender device 220 to determine and issue a notification in accordance with a notification priority determined by the message handler 100.

In various example embodiments, the sender device 220 performs a notification process 228, in which the sender device 220 may use a sender-side messaging GUI to present a notification to the message initiator regarding the response. In some example embodiments, the sender device 220 may determine the type of notification presented, the timing of the notification, and whether the notification is interruptive or non-interruptive. In other example embodiments, the response related information received from message handler 100 includes a predetermined notification type, predetermined notification timing, and whether the notification is interruptive or non-interruptive. In some example embodiments, the notification may be presented outside of the sender-side messaging GUI, even though a computer executable program or application used to implement a sender-side terminal of the messaging system may control activation of the notification. Note that in some example embodiments, depending on the notification channel, the messaging system application on the sender device 220 may not be used to generate the notification. For example, if a low-priority notification is set to be delivered by email, an email application running on the sender device 220 may generate a standard email notification according to system settings.

In some example embodiments, the message handler may deliver email, text, or other notifications via external systems if the notification priority associated with those notifications is not set to the highest priority level. Thus, for example, an email notification may be delivered to an external email system (not illustrated), a text message notification may be sent to a communications carrier (not illustrated), or the like. In some example embodiments, a confirmation notification indicating the external channel or system by which the notification was delivered, as well as timing or other information, may be transmitted to the sender device 220 in lieu of, or in addition to, transmitting the notification to the sender device 220.

In at least one example embodiment, some or all notifications, regardless of the notification priority, are issued within a messaging system or platform, which includes a first messaging program or application being executed on the sender device 220, the message handler 100, and a second messaging program or application being executed on the recipient device 240. In one such example embodiment, any alerts presented to message initiator 210 are presented under the control of, or at the direction of, the first messaging program or application being executed on sender device 220. As illustrated by external communication switchover instruction 229, and as discussed subsequently with respect to FIG. 1000, the message initiator 210 may be presented with an option to continue a conversation via a communications channel external to the messaging system or platform. In response to receiving an external communication switchover instruction 229, the first messaging program or application being executed on sender device 220 may perform an external messaging application activation process 231, which opens an external messaging application for use by the message initiator.

In some example embodiments, the switchover itself may be logged by the messaging system or platform, but future communications between the message initiator 210 and the message recipient 250 are conducted outside of the messaging system or platform, and are not logged or otherwise processed by the messaging system. Examples of communications channels external to the messaging system or platform include, but are not limited to social media messaging platforms, SMS or MMS messaging services available through various smartphones and mobile carriers, email systems, or the like.

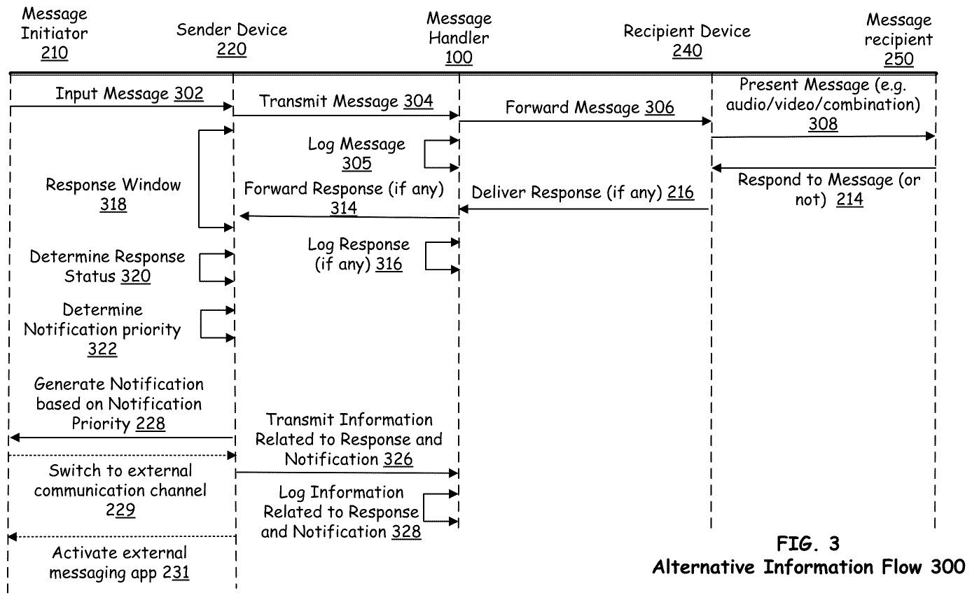

Referring next to FIG. 3, an alternative information flow diagram 300 illustrating an alternative message flow within a messaging system, such as messaging system 100, will be discussed in accordance with various example embodiments. In at least one example embodiment, the individual processes illustrated by the alternative information flow diagram 300 are similar to the individual processes discussed with reference to the first information flow diagram 200 (FIG. 2), except that some of the messaging and/or notification processes may be performed by the sender device 220 rather than by the message handler 100. Details of processes that have already been discussed with reference to FIG. 2 may be omitted from the discussion of FIG. 3.

In various example embodiments, message initiator 210 may, during a message input process 302, input a message intended for message recipient 250 into a sender-side GUI displayed on sender device 220. In contrast to the input operation 202 (FIG. 2), the message initiator 210 may not provide explicit transmission instructions during the message input process 302. In response to receiving input from message initiator 210, the sender device may execute a message transmission process 304 to transmit that message to message handler 304 for later forwarding to the recipient device 240. In response to transmitting the message during message transmission process 304, the sender device opens a device response window 318, which functions similarly to the message handler response window 218 (FIG. 2).

In some example embodiments, the message handler 100 has been pre-configured to perform a message forwarding process 306 in response to receiving a message from message initiator 210 that does not include explicit transmission instructions. The forwarding process 306 may include forwarding a received message to a recipient identified in the message. The forwarding process 306 may also include determining whether the message includes transmission instructions by testing a bit in the header, trailer, or payload of the received message. The forwarding process 306 may also include determining a network address to which the received message is to be delivered based on a profile, recipient, sender, session, or other identifier included in the header, trailer, or payload of the received message. For example, a received message may include a profile identifier corresponding to a profile stored in the profiles/instructions datastore 118 (FIG. 1). The message handler may, for example, obtain a network address of the recipient device 240 directly from the received message, look-up and retrieve the corresponding profile information, and determine a network address of the recipient device 240 based on the profile information, or the like.

The recipient device 240 performs a forwarded message presentation operation 308 in response to receiving the forwarded message. The forwarded message presentation operation 308 is similar to the message presentation operation 212 (FIG. 2), and may include presenting audio information, video information, and/or some combination thereof via a recipient-side GUI. The recipient-side GUI may include user-selectable objects, text entry fields, drop down menus, file attachment fields, or the like. In various example embodiments, the recipient-side GUI is configured to receive input from the message recipient 250 to be delivered to the message initiator 210. This input may include an explicit indication of urgency, for example selection of a red-colored indicator specifying a high level of urgency, selection of a yellow-colored indicator specifying a medium level of urgency, or selection of a green-colored indicator specifying a low-level of urgency. Alternatively or in addition, the message recipient 250 may provide input content that may be analyzed, either by message handler 100 (see FIG. 2) or sender device 220 (see FIG. 3) to determine a level of urgency.

For example, the input provided by the message recipient may include text, where the text may include predetermined keywords or language structure signaling a level of urgency, images that may be processed by an AI model configured to correlate image content with an estimated level of urgency, voice patterns that indicate a level of urgency, or the like. In various example embodiments, off-the-shelf AI models may be provided with training images marked with various levels of urgency to customize the AI model to match particular images with particular urgency levels. Various off-the-shelf voice recognition software may be used to detect voice patterns and inflections. Customized off-the-shelf AI models may be used to analyze the detected voice patterns and/or word usage to associate audio content with particular levels of urgency.

In various example embodiments, the message recipient 250 may decline to input a response to the message, may inadvertently fail to input a response to the message, or fail to respond to the message because the message recipient 250 is unaware that a message has been received. In response to receiving a response input from the message recipient 250, the recipient device 240 may perform a recipient response delivery operation 216, as previously discussed with reference to FIG. 2. In at least one example embodiment, the recipient device 240 does not perform the recipient response delivery operation 216 unless and until message recipient 250 provides response input. In other example embodiments (not illustrated), the recipient device 240 may report presentation of the message to the message recipient, which may provide an additional data point for message handler 100 and/or sender device 220 to use when determining a notification priority.

The message handler 100 performs a response forwarding process 314 in response to receiving an affirmative response from recipient device 240. In the illustrated example embodiment of FIG. 3, if no response is received by the message handler 100, message handler 100 does nothing. In other example embodiments, message handler 100 may open a message handler response window 218 (FIG. 2), and report to sender device 220 that no response was received within the message handler response window 218. The message handler response window 218 may be used in place of, or in addition to, device response window 318.

In the illustrated example embodiment, sender device 220 performs a device-side status response determination 320 and a device-side notification priority determination 322, which function the same way as the handler-side response status determination 222 (FIG. 2) and the handler-side notification priority determination 224 (FIG. 2), with the exception of being performed by a different device. The sender device 220 initiates the same notification process 228 discussed with reference to FIG. 2 to determine and initiate an appropriate notification type and/or channel. In at least one example embodiment, selecting the notification type and/or channel include using a lookup table or other data structure that linking particular notification types and/or channels to particular notification priorities. In some example embodiments (not illustrated), selecting the notification type and/or channel may include querying message handler 100 for additional information.

As also discussed with reference to FIG. 2, some or all notifications, regardless of the notification priority, may be issued within the messaging system or platform, while follow-on communications may be switched to an external communications system in response to an external communication switchover instruction 229.

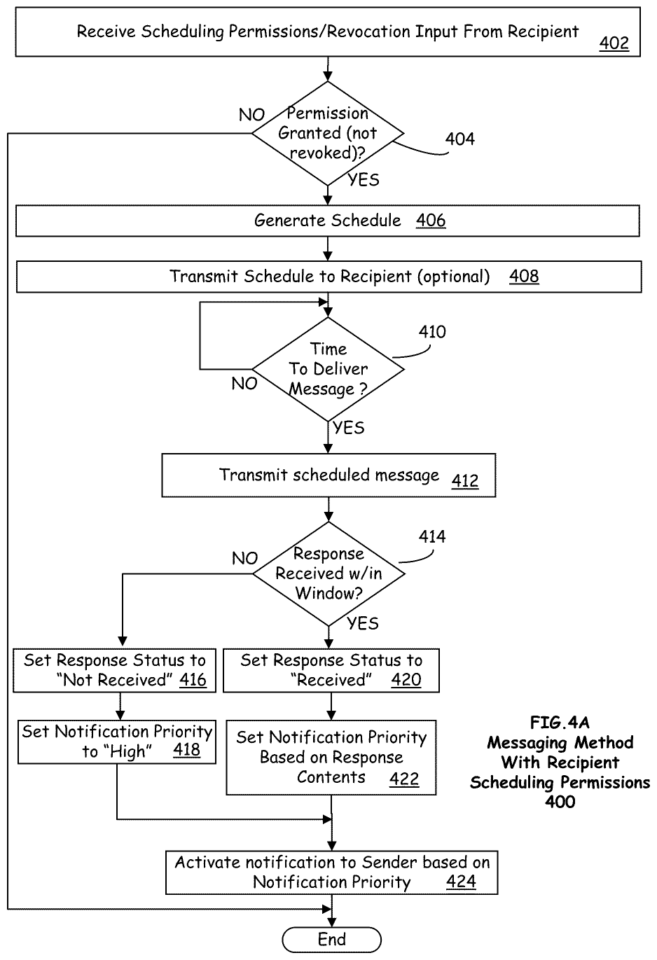

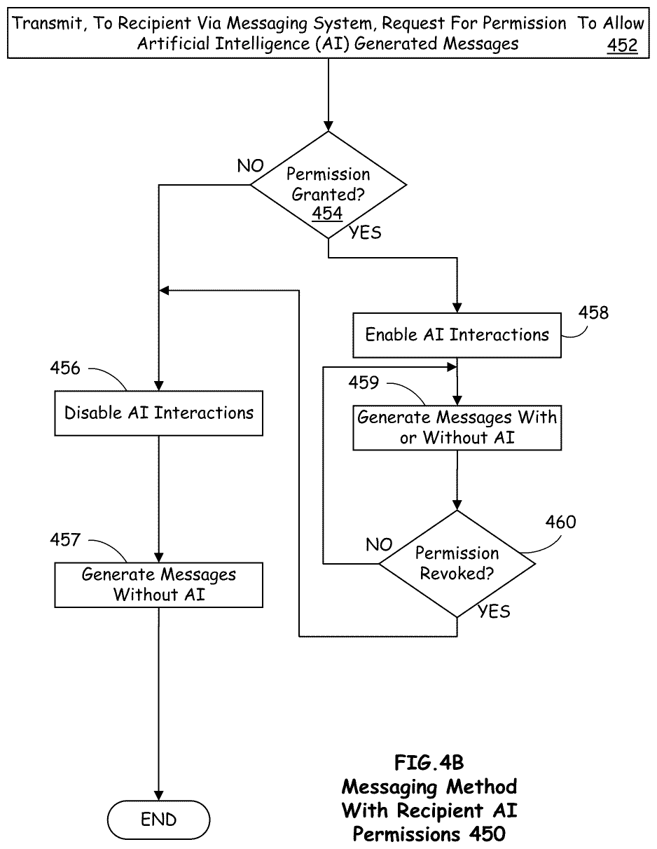

Referring next to FIG. 4A, a first messaging method 400, which implements recipient scheduling permissions, will be discussed in accordance with various example embodiments. As illustrated by block 402, a message recipient may provide scheduling permission revocation. In some example embodiments, the message recipient may provide permission input in response to a request for permission to schedule future delivery of one or more messages. In some example embodiments, request may be presented to the recipient during setup of the messaging application on the recipient's device. The request may be delivered to the recipient via a recipient-side messaging application running on recipient device, such as recipient device 240. In some example embodiments, the message may be generated by a user sending the request on its own behalf, or generated by a messaging server, such as message handler 110 (FIG. 1). In at least one example embodiments, the request is considered to be a request for revokable, durable permission to send any number of future messages. In some example embodiments, the request may include a proposed messaging schedule. The recipient may or may not be permitted to request modifications to the proposed messaging schedule. In at least one example embodiment, the first messaging method 400 is performed by a messaging server, such as the messaging server 110 (FIG. 1) in response to transmission instructions received from a message initiator, as part of setting up a recipient's profile, or the like. In some implementations, the request may be a separate message, or be transmitted to a recipient device in response to the recipient accessing a website. Additionally, the recipient may be asked to agree to receiving future messages in general, without regard to any particular schedule. Additionally or alternatively, the message recipient may, at any point during or after initial setup, for example during the course of providing preferences for inclusion in a recipient profile, send scheduling permission/revocation input indicating that permission for a series of scheduled messages to be sent on behalf of the sending user has been newly permitted or revoked.

As illustrated by block 404, a check is made to determine if the recipient has granted the request with or without modification. In various example embodiments, the results of this determination may be stored in a datastore accessible to the message handler 110 as part of profile information associated with a message sender, a message recipient, or the like. If the recipient denies the request to receive scheduled future messages, by rejecting any future messages or by rejecting a particular schedule, the first messaging method 400 ends.

As illustrated by block 406, if permission is granted to receive future messages, a schedule for transmitting messages to the recipient will be generated. Generating a message schedule may include retrieving a message schedule from a datastore, generating a messaging schedule of in accordance with transmission instructions, obtaining a schedule from a user, pseudo randomly selecting messaging times within specified daytime periods, or the like.

As illustrated by block 408, the messaging schedule may optionally be transmitted to the recipient via the recipient-side messaging application. The recipient-side messaging application may automatically populate a calendar to which the recipient-side messaging application has been granted access, or populate a calendar that is part of the messaging system itself. In some example embodiments, the message handler 100 (FIG. 1) may populate a calendar and transmit the calendar to the recipient-side messaging application. Transmitting the messaging schedule may include transmitting one or more dates and times defining a message receipt window during which the recipient should expect to receive a message. A messaging schedule transmitted to a recipient may omit the subject and/or the content of one or more scheduled messages.

As illustrated by block 410, the message handler waits to transmit a message until the time scheduled for message transmission. As illustrated by block 412, the message is transmitted at the scheduled time. As discussed with respect to FIG. 2, in response to transmitting a message to the recipient, the message handler 110 may open a message-handler response window 218.

As illustrated by block 414, if no response from the message recipient is received before the response window has closed, a response status is set to “not received” at block 416, and the notification priority set to high at block 418. As further illustrated by block 414, if a response from the message recipient is received before the response window has closed the response status is set to “received” at block 420, and a notification priority may be set to a level determined by analysis of the contents of the response at block 422.

As illustrated by block 424, the sender on behalf of whom the message was sent is notified of the receipt/non-receipt of the message in accordance with the notification priority. Under a mandatory response notification protocol, block 424 notifies the sender regardless of whether the response message was affirmatively received or not. The message handler 110 may transmit a notification command to a sender device. The notification command may be executed by a sender-side terminal of the messaging system through various mechanisms to which the sender-side device has access, whether within a sender-side messaging GUI, via a channel outside the sender-side messaging GUI, or some combination thereof. Notifications may include a tactile notification, a visual notification, an audio notification, or some combination thereof. In some example embodiments the message handler 110 activates the notification to the sender by providing information to one or more of a sender's devices, as opposed to commanding execution of the notification. In yet other example embodiments, the message handler 110 may transmit a receipt/non-receipt notification to the sender via a channel external to the messaging system.

Referring next to FIG. 4B, a second messaging method 450, which implements recipient AI permissions, will be discussed in accordance with various example embodiments. In various example embodiments, implementation of an AI permission/revocation process is similar to the permission/revocation process for scheduling, as discussed in FIG. 4A. As an initial matter, it should be understood that, for purposes of this disclosure, AI-generated messages are considered to be sent on behalf of the sending user (e.g. message initiator 210 of FIGS. 2-3).

As illustrated by block 452, a message may be transmitted to a message recipient 250 (FIGS. 2-3) via message handler 100 (FIGS. 1-3), requesting the message recipient's permission to allow delivery of AI-generated messages. In some example embodiments, AI permissions may be granted and revoked through message sender and/or message recipient preferences, profiles, etc., rather than via an explicit grant request transmitted to the recipient. The grant and/or revocation of AI permissions are processed and enforced, in at least one example embodiment, by message handler 100. AI permissions may be stored, for example, in the profiles/instructions datastore 118, although they may be stored in any appropriate datastore.

As illustrated by block 454, a check is made to see if the recipient has granted permissions to receive AI generated messages on behalf of the sending user. If no permission has been received, AI messaging interactions are disabled at block 456. AI messaging interactions include, but are not limited to, generating messages, reading messages, selecting messages, modifying message content, determining schedules, generating automated follow-up replies to recipient responses, or the like. In at least one example embodiment, full or partial permissions for AI messaging interactions may be granted and/or revoked. In a non-limiting example, AI scheduling may be permitted, AI generated replies to recipient responses may be prohibited, and modification of any messages may be permitted.

As illustrated by block 457, generation of messages and similar messaging interactions via AI are inhibited/blocked/bypassed. I f, however, the check at block 454 indicates that AI permissions have been granted, AI messaging interactions are enabled at block 458. As illustrated by block 459, enabling AI messaging interactions does not require the use of AI to generate all messages, but provides that option to the sending user. For example, a sending user may decide not to use AI for some messages but to use AI to generate other messages. In various example embodiments, AI may be used for all messages, for some messages, for parts of all messages, for some parts of some messages, or the like. In at least some example embodiments, profiles or instructions stored in the profiles/instructions datastore 118 may be used to set guardrails on the content generated by AI. In various example embodiments, the recipient may be prohibited from using AI to generate responses. Such a prohibition may be enforced using currently available bot and AI detection mechanisms, by preventing cut and paste answers in responses provided by a message recipient, or the like. In at least one example embodiment, even if a recipient were to use an external AI system to generate a response, then paste it into a response message, the messaging system's AI may be configured to accept prompts from sending user's, but not message recipients.

As illustrated by block 460 a check can be made periodically, or prior to performing message generation or any other recipient interaction, to determine if permission to use AI has been revoked. If permission has been revoked, second method 450 proceeds to block 456, where AI messaging interactions are disabled. If permissions have not been revoked, the method returns to block 459.

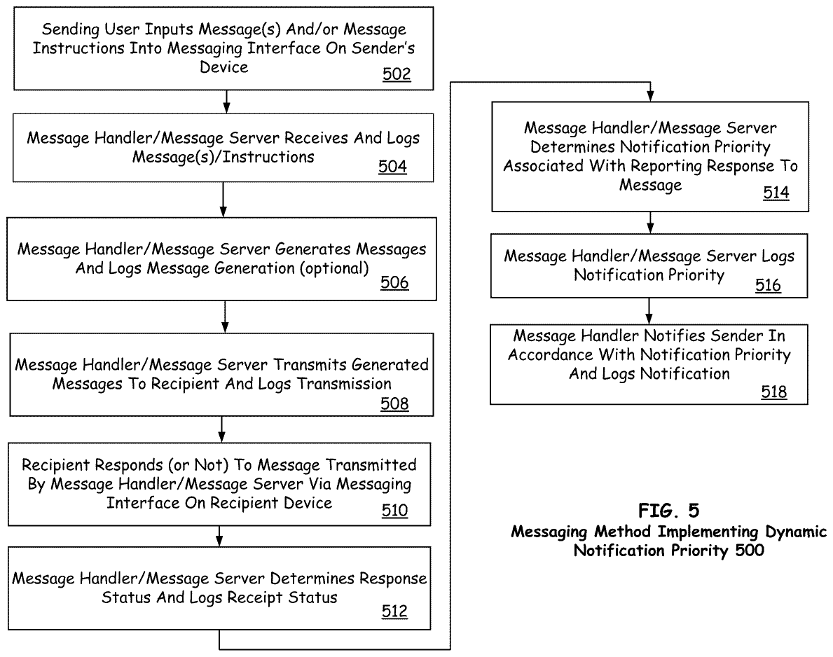

Referring next to FIG. 5, a third messaging method 500, which implements a dynamic notification priority, will be discussed in accordance with various example embodiments. As illustrated by block 502, a sending-user inputs messages and/or message/transmission instructions into a messaging interface being executed on the sender's device. The message/transmission instructions may include, but are not limited to, scheduling information, content identifiers, sender/recipient identifiers, profile identifiers, message content, message template identifiers, and the like.

As illustrated by block 504, a messaging server receives and logs the messages and/or instructions in one or more datastores accessible to the messaging server. If the messaging server receives a message to be forwarded, but the message does not include additional instructions, receipt of that message is logged. The message may be forwarded in the future or immediately, in accordance with default messaging server settings, in accordance with previously received instructions, in accordance with a sender, user, or session profile, or the like. In cases where both a message and instructions are received, a message may be forwarded in accordance with those instructions, a new message may be generated based on the content and/or style of the received message. The generated message may be sent in accordance with the received instructions. Where only instructions are received, a new message may be generated in accordance with those instructions, or the instructions may be saved for later use, as part of a sender, recipient, or session profile, or the like.

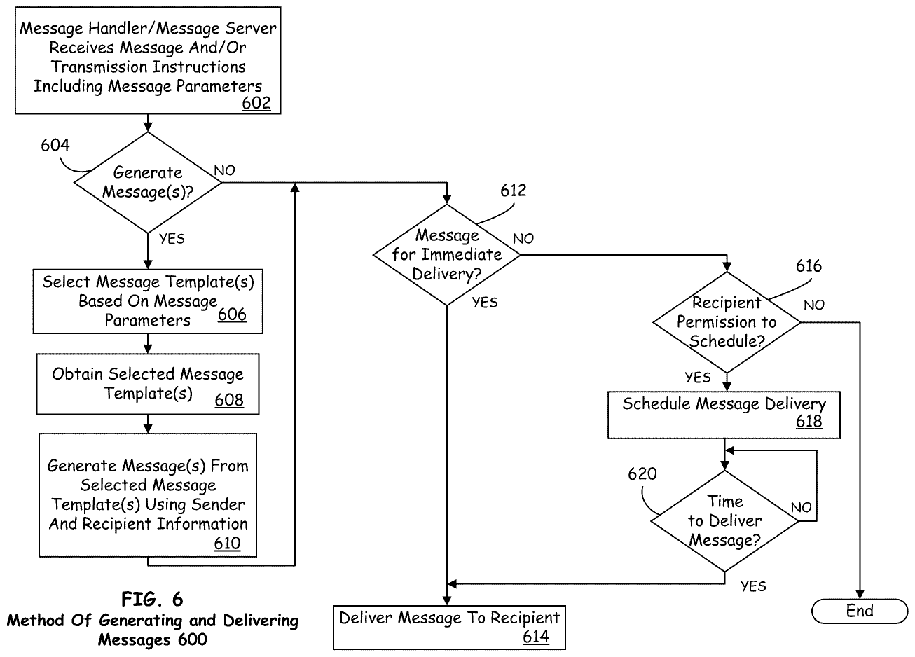

As illustrated by block 506, the messaging server optionally generates one or messages in accordance with the message/transmission instructions received from the sending-user, and logs information pertinent to the message generation process. The logged information may include data sources used in generating the message, a pointer to instructions used to generate the message, a recipient of the message, a sender on whose behalf the message is being generated, files attached to the message, or the like. The message may be generated contemporarily with transmission of the message, or in advance of transmission and stored until a time indicated by a message transmission schedule. Message generation will be discussed further in relation to FIG. 6.

As illustrated by block 508, the messaging server transmits a received or generated message, and logs details associated with the transmission, including message source, destination, timestamps, a location of the message within a datastore, or the like. In response to transmitting the message, the messaging server may also open a response window defining a period during which receipt of a response is expected.

As illustrated by block 510, a recipient may either respond or not-respond to the message transmitted by the messaging server at block 508. As illustrated by block 512, the messaging server determines a response status indicating whether a response to the message transmitted at block 508 has been received from the message recipient prior to expiration of the response window. Thus, if a response is received from the recipient within the response window, the response status may be set to “received,” but if a response is not received before the response window closes, the response status will be set to “response not received.”

As illustrated by block 514, the message server determines a notification priority associated with reporting the recipients response (or non-response). In at least one example embodiment, determining a notification priority is set to high if the response status is “no response.” But if a response is received, the contents of the response are evaluated to determine the notification of priority. This process results in a dynamic notification priority that cannot be determined at the time a message is sent. Instead, the notification priority is unknown until a recipient's response is returned and evaluated by a messaging server, a sender-side messaging application, or some other part of the messaging system, depending on the specific implementation.

As illustrated by block 516, the message server logs notification priority it has determined. The message server notifies the sender in accordance with the notification priority, and logs the notification, as illustrated by block 518.

Referring next to FIG. 6, a fourth method 600 of generating and delivering messages will be discussed in accordance with various example embodiments. As illustrated by block 602, a message handler/message server receives a message and/or message/transmission instructions including message parameters. Message parameters, as used herein, are a subset of transmission instructions, and refer generally to instructions and information used in the process of generating a message on behalf of a sender. Message parameters may include, but are not limited to, template identifiers, profile identifiers, sender and/or recipient identifiers, information indicating a tone, reading/vocabulary level, formality level, subject matter, messaging frequency, question sets, language, response window durations or adjustments to response window durations, message blackout times, message retention information, a presentation sequence within or between messages, content to avoid including messages, or the like.

As illustrated by block 604, the message handler/message server determines whether a message to a recipient is to be generated. This determination may be based on a schedule, the message parameters, and/or other transmission instructions. As illustrated by block 604, if a message to be forwarded has been received, the determination will result in third method 600 proceeding directly to block 612, but if the determination at block 604 indicates that a message is to be generated, the message will be generated as illustrated by blocks 606-610 before the third method 600 proceeds to block 612.

As illustrated by block 606, if it is determined at block 604 that a message is to be generated, the message handler/server selects a message template(s) based on the message parameters, obtains the selected message template(s) as illustrated by block 608, and generates one or more message(s) based on the selected message template(s).

In an example of operation a message may be generated using a template obtained from a templates/message generation content store 116 (FIG. 1). The template may be populated with personalized message content, such as names, addresses, references to previous messages and/or responses, and other similar information in accordance with information retrieved from one or more datastores, such as those discussed with respect to FIG. 1, using a profile identifier, a sender identifier, and/or a recipient identifier. In some example embodiments, audio, visual, and/or textual files may be attached to the message by the messaging server in accordance with the message/transmission instructions.

As illustrated by block 612, a check is made to determine whether a message received at block 602, or a message generated at blocks 606-610, is to be immediately transmitted to a message recipient. This determination may be made based on a schedule, based on default rules, based on previously provided instructions, and/or based on transmission instructions received at block 602. If the message is to be delivered immediately to the recipient, the message is transmitted, as illustrated by block 614.

As illustrated by block 616, if the message is to be delivered according to a schedule, a check may be made to determine whether the recipient has granted permission for the messaging server to transmit scheduled messages. It will be appreciated that in some example embodiments, this check, and the check at block 612, may be implemented prior to generating the message at blocks 606-610, to prevent the possibility that a message would need to be discarded after spending resources generating the message. In the illustrated example embodiment, if permission to transmit scheduled messages has not been granted, the method ends.

As illustrated by block 618, if transmission of scheduled messages to the recipient is approved, the message, whether received at block 602 or generated at blocks 606-610, may be stored and scheduled for future delivery. As illustrated by block 620 the messaging server waits until the scheduled message delivery time, and then transmits the message as illustrated by block 614.

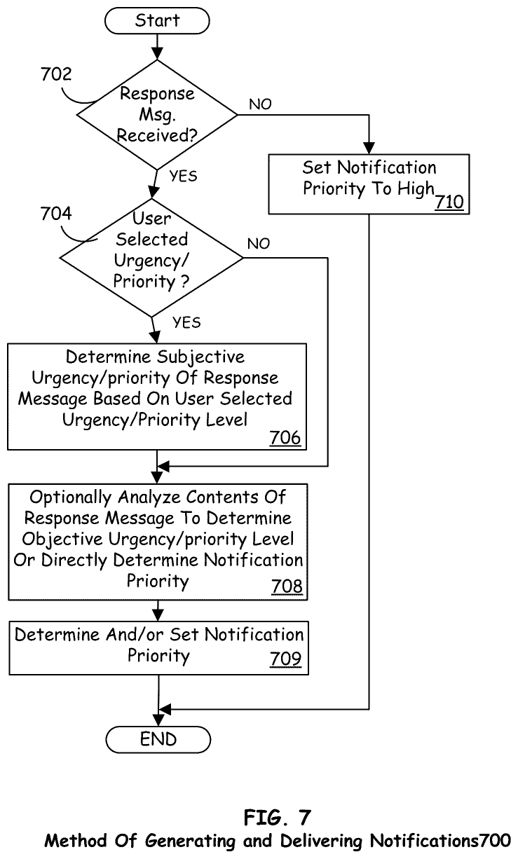

Referring next to FIG. 7, a fifth method 700 of generating and delivering notifications and notifications will be discussed in accordance with various example embodiments. As an initial matter, this discussion distinguishes between user selected urgency levels included in a response messages, which provide the user's subjective opinion of the urgency of the response message, and message content that may be analyzed to obtain an objective indication of the response message's urgency. User-selected urgency indicators are not considered to be part of the response message content evaluated to determine an objective indication of response message urgency.

As illustrated by block 702, a processing device, which may include, for example, the message handler 110 (FIG. 1) or the sender device 220 (FIG. 2), determines whether a response message has been received from a message recipient via, for example, a recipient device 250 (FIG. 2). Details related to message flows between a sender device 220 and a recipient device 250 have been disclosed discussed more fully with respect to FIGS. 2-3. If it is determined at block 702 that no response message has been received, the notification priority is set to high, as illustrated by block 710, and the method ends. If a response message has been received, the method proceeds to block 704.

As illustrated by block 704, if the determination at block 702 indicates that a response message has been received, the message handler 110 (FIG. 1) or the sender device 220 (FIG. 2) may determine whether the content of the response message includes a user-selected urgency or priority level. If the determination at block 704 indicates that the response message includes a user-selected urgency/priority level for the response message, the method proceeds to block 706. However, if the determination at block 704 indicates that the response does not include a user-selected urgency or priority level, the method proceeds to block 708, where the contents of the response message are optionally analyzed to determine an objective indication of the response message's urgency/priority level, which may then be used as a basis for setting a notification priority.

Note that a response message's urgency/priority level, should not be conflated with the notification priority. Also recall that for purposes of analyzing the contents of the response message to determine an objective indication of the response message's urgency/priority, the user-selected urgency/priority is not considered to be part of the response message contents, and is thus excluded from the content analysis at block 708.

As illustrated by block 706, if a response message includes a user-selected, response message urgency/priority level, the notification priority is determined, at least in part, based on the explicitly specified urgency or priority level. In some example embodiments, for example, there may be three urgency/priority levels options that may be selected for inclusion in the response message by the recipient of the original message: not-urgent, moderately urgent, or highly urgent. In some example embodiments, other than three response message urgency/priority levels may be used. In further example embodiments, there may not be a one-to-one correspondence between response message urgency levels and notification priorities. For example, response messages marked highly urgent or moderately urgent may both be mapped to a “high” notification priority, while response messages marked not-urgent may be mapped to a low notification priority.

In other example embodiments, a response message marked with a particular urgency/priority level may be mapped to one of multiple different notification priorities based on sender, recipient, and/or session profiles, times when responses are sent, or the like. For example, a moderately urgent response message sent at 2 am may be marked with a medium high notification priority, allowing a non-disruptive notification to be issued, while that same response message sent during business hours may be marked with a high notification priority, requiring a disruptive notification to be issued. In other example embodiments, a first number of response message-urgency levels may be mapped to a second number of notification priorities. Thus, for example 3 response message urgency levels may be mapped to 4 or 5 notification priorities in one implementation, while another implementation maps 4-5 response message urgency levels to 2 or 3 notification priorities. In alternative example embodiments, the urgency levels associated with the response message may have a 1-1 correspondence with the notification priorities.

As illustrated by block 708 the contents of the response message may be optionally analyzed to determine a notification priority. As shown by FIG. 7, block 708 may be performed in addition to, or instead of, block 706. In an example embodiment, if there is no user-selected urgency/priority level, as determined at block 704, block 708 may determine an objective urgency/priority level of the response message based on the contents of the response message. The objective urgency/priority level determined at block 708 may then be used to determine a notification priority. In another example embodiment, if there is no user-selected urgency/priority level, as determined at block 704, block 708 may directly determine the notification priority based on the contents of the response message.

In yet other example embodiments, if the result of the determination at block 704 indicates that there is a subjective, user-selected urgency/priority level included in the response message, block 708 may be performed in addition to block 706, so that both a subjective and objective response-message urgency/priority level may be determined. In some example embodiments, when determining the notification priority at block 708, both the subjective and objective urgency/priority levels of the response message may be used in determining the notification priority.

As illustrated by block 709, the processing device(s) executing fourth method 700 may determine and/or set the notification priority in accordance with the determinations made at block 706 and/or block 708.

Consider the following series of operational examples. In a first example, assume that a subjective urgency/priority level of a response message, as determined based on user-selected input at block 706, is “low.” Further assume in this first example, that the content of the response message is not analyzed at block 708. In the first example, block 709 may set the notification priority based on the subjective urgency/priority level of the response message, which was selected by the recipient.

Consider now a second example, in which the subjective urgency/priority level of a response message is “low,” but the content of the response message is analyzed at block 708 to determine an objective urgency/priority level of the response message. Further assume that the objective urgency/priority level of the response message is “high.” This may occur, for example, if there are keywords in the response message indicating that the recipient is distressed, angry, or confused, if the tone of the response message is at odds with the user-selected urgency/priority, if the contents of file links in the response message or files attached to the response message include images, audio content, or textual content that is inconsistent with the user-selected urgency/priority level, or the like. In some such example embodiments, a disagreement between the subjective and objectively determined urgency/priority level of the response message may be handled in various different ways including, but not limited to: basing the notification priority on the user-selected urgency/priority level and ignoring the urgency/priority level determined based on the contents of the message; basing the notification priority on the urgency/priority level determined based on the contents of the message and ignoring the user-selected urgency/priority level; or combining the subjectively and objectively determined urgency/priority levels to obtain a modified urgency/priority level. Combining may include weighted averaging, with the weights determined based on historical subjective urgency/priority levels associated with a particular recipient or session, assigning weights based on input by a sending-user, or using another suitable combination technique.

In a third example, assume that it is determined, based on block 704, that there is no subjective urgency/priority level included in a response message. In this example, block 709 may determine the notification priority based on the objective urgency/priority level of the response message, which was determined at block 708 based on an analysis of the contents of the response message. In a fourth example, similar to the third example, block 709 may set the notification priority based on a notification priority determined at block 708. The primary difference being illustrated between example three and example four is that in example four block 708 directly determines the notification priority based on the contents of the response message, rather than making the intermediate determination about the urgency/priority of the response message. In both of these cases, the objective urgency/priority level of the response message, which was determined at block 708 based on an analysis of the contents of the response message.

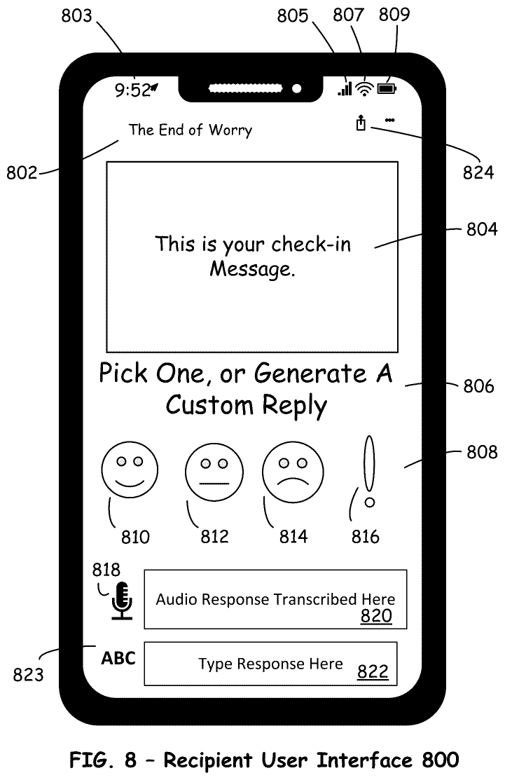

Referring next to FIG. 8, a recipient user interface 800 will be discussed in accordance with various example embodiments. The recipient user interface 800 is a graphical user interface (GUI) generated by an instance of a program of instructions configured to be executed on a recipient's endpoint user device. The recipient user interface 800 is part of a messaging system, such as the messaging system 100 (FIG. 1.), and allows recipients to interact in a seamless manner with other parts of the messaging system.

The recipient user interface 800 is illustrated as including a branding area 802, indicating a messaging system or service to which the recipient user interface 800 provides access; various system indicators, such as clock 803, mobile carrier signal strength indicator 805, wireless network strength indicator 807, and battery level indicator 809; an upload response/send indicator 824; a message display area 804, which is used to display incoming messages sent on behalf of a message initiator; an instruction area 806; and user-selectable urgency/priority objects including a low-urgency object 810, an mild-urgency object 812, an elevated-urgency object 814, and a highly-urgent object 816. The user-selectable urgency/priority objects may include fewer objects, for example 3 differently colored buttons-for example green, yellow, and red, may be presented as a sliding scale object that can be manipulated to point to a user-selected urgency/priority level, may be presented as a number scale, e.g. 1-5, 1-3, 1-10, or the like. In some example embodiments the recipient may choose a user-selectable urgency/priority from a dropdown menu. In yet other example embodiments, the user-selectable urgency/priority may include selection of a number of hours, days, weeks, or months at which the recipient desires to receive another message.

The recipient user interface 800 is also illustrated as including a user selectable microphone object 818 displayed in conjunction with an audio transcription area 820; and a text-indicator 823 displayed in conjunction with a text entry area 822. In at least some example embodiments, other recipient screens may be presented to a recipient depending on a use context, and/or a menu selection on a “home” screen of the recipient user interface 800. For example, various screens may include input options for responding to scheduling requests, attaching files, or the like.

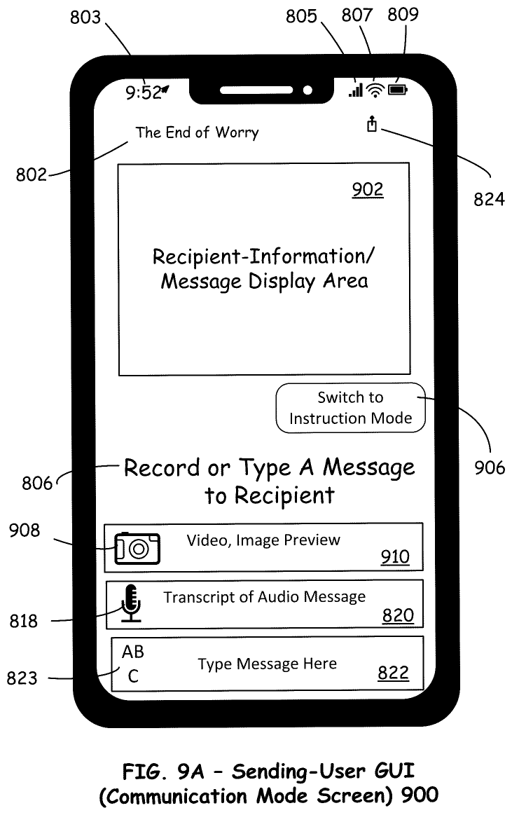

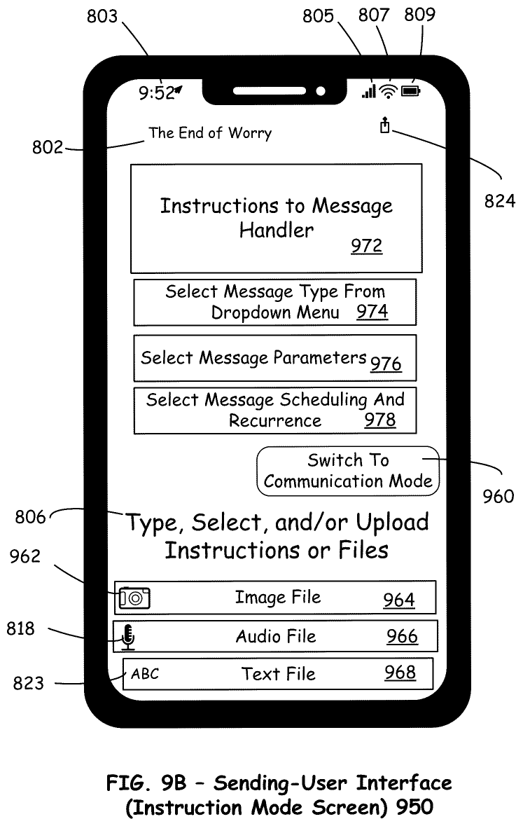

Referring next to FIG. 9A, a communications mode screen 910 of a sending-user's graphical user interface GUI will be discussed in accordance with various example embodiments. In at least one example embodiment, the communications mode screen 910, is presented as part of a sending-user's GUI generated by an instance of a program of instructions configured to be executed on a sending-user's endpoint user device, for example a sending user's 2^{nd} device 144 (FIG. 1). The sending-user interface in a communications mode 900 is part of a messaging system, such as the messaging system 100 (FIG. 1.), and allows a sending-user to interact in a seamless manner with other parts of the messaging system. The sending-user interface in a communications mode 900 may be used by the sender to compose a message to be transmitted a message recipient by the sending-user's device, or to be transmitted to a message handler for forwarding, substantially as-is, to the message recipient.

The sending-user interface in a communications mode 900 is illustrated as including a branding area 802, indicating a messaging system or service to which the sending-user interface in a communications mode 900 provides access; various system indicators, such as clock 803, mobile carrier signal strength indicator 805, wireless network strength indicator 807, and battery level indicator 809; an upload response/send indicator 824; and a recipient-information/message display area 902. The recipient-information/message display area 902 may be used to display information related to a message recipient and/or to display a message to the recipient, giving the sending-user easy access to information that may be useful in creating a message to that recipient. In some example embodiments, the message recipient may be selected from another GUI screen (not illustrated), from a dropdown menu (not illustrated), or the information for a particular recipient may be populated in response to a received response message.

The sending-user interface in a communications mode 900 is also illustrated as including a Switch-to-Instruction-Mode object 906, which may be selected by a sending-user to cause the sending-user interface to switch to display a sending-user interface in an instruction mode, as discussed subsequently with respect to FIG. 9B. The sending-user interface in a communications mode 900 is also illustrated as including an instruction area 806; a video image preview area 910, which may be used to preview a video message being recorded by the sender; an audio transcription area 820, which may be used to display a text transcript of an audio message being recorded; and a text entry area 822, which may be used to enter text to be included in a message. A video object 962 may be displayed in conjunction with the video image preview area 910, and may be activated by the sending-user to initiate recording of a video message. A user selectable microphone object 818 may be displayed in conjunction with the audio transcription area 820, and may be activated by the sending-user to initiate recording of an audio message. A text-indicator 823 may also displayed in conjunction with the text entry area 822.

Referring next to FIG. 9B, a sending-user interface in an instruction mode 950 will be discussed in accordance with various example embodiments. The sending-user interface in an instruction mode 950 is a graphical user interface (GUI) generated by an instance of a program of instructions configured to be executed on a sending-user's endpoint user device. The sending-user interface in an instruction mode 950 is part of a messaging system, such as the messaging system 100 (FIG. 1.), and allows a sending-user to interact in a seamless manner with other parts of the messaging system. The sending-user interface in an instruction mode 950 may be used by the sender to compose, select, and/or generate transmission instructions such as template identifiers, message parameters, and schedules related to a message to be delivered to a message recipient. The transmission instructions may be transmitted to a message handler, such as message handler 110 (FIG. 1) to allow the message handler to generate a message, and to transmit the generated message, on behalf of the sending-user. In some example embodiments, the transmission instructions may be sent in conjunction with an existing message, and may be used to provide instructions regarding scheduling, or the like. In various example embodiments, the transmission instructions provide instructions that provide the message handler with preferences and/or other information used by the message handler to perform one or more tasks on behalf of a sending-user.

The sending-user interface in an instruction mode 950 is illustrated as including a branding area 802, indicating a messaging system or service to which the sending-user interface in an instruction mode 950 provides access; various system indicators, such as clock 803, mobile carrier signal strength indicator 805, wireless network strength indicator 807, and battery level indicator 809; an upload response/send indicator 824; and an instructions display area 972, which may be used to display current instructions, parameters, etc. to be provided to the message handler. In various example embodiments, the instructions display area 972 may display custom instructions typed directly into the instructions display area 972, file names and/or locations of instruction files to be delivered, profile identifiers, schedules, and/or other instructional information to be used by the message handler.

The sending-user interface in an instruction mode 950, as illustrated, also includes a message type dropdown menu 974, which may indicate whether a message is a test message, a check-in message, a follow up message to a low urgency response message, a follow up message to a high urgency response message, a social message, a message associated with a particular topic, or the like. The sending-user interface in an instruction mode 950 may also include a message parameters dropdown 976, which allows the sender to select one or more message parameters; a message scheduling dropdown 978, which allows the sender to select a transmission schedule to be used for one or more messages to be delivered to one or more recipients; and a Switch-to-Communication-Mode object 960, which may be selected by a sending-user to cause the sending-user interface to switch to display a communications mode, as discussed previously with respect to FIG. 9.

The sending-user interface in an instruction mode 950 is also illustrated as including an instruction area 806; an image file area 964, which may be used to display identification and/or address information for image files selected for upload to the message handler, including but not limited to video messages to be forwarded to a recipient; an audio file area 966, which may be used to display identification and/or address information for audio files selected for upload to the message handler, including but not limited to previously recorded audio messages to be forwarded to a recipient; and a text file area 968, which may be used to display identification and/or address information for audio files selected for upload to the message handler, including but not limited to previously recorded text messages to be forwarded to a recipient. A video object 962 may be displayed in conjunction with the image file area 964, and may be activated by the sending-user to initiate selection and/or uploading of a video file. A user selectable microphone object 818 may be displayed in conjunction with the audio file area 966, and may be activated by the sending-user to initiate selection and/or uploading of an audio file. A text-indicator 823 may be displayed in conjunction with the text file area 968, and may be activated by the sending-user to initiate selection and/or uploading of a text file.

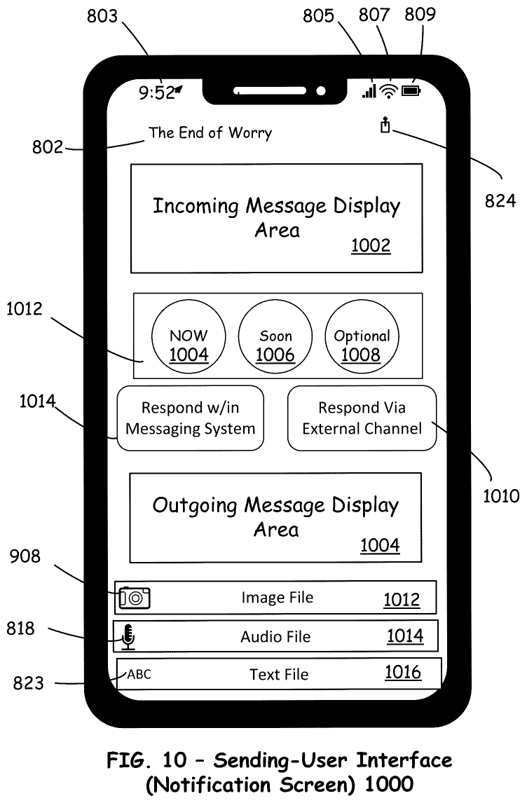

Referring next to FIG. 10, a notification screen 1000 of a sending-user interface, will be discussed in accordance with various example embodiments. In at least one example embodiment, the notification screen 1000 may be displayed automatically in response to activation of a response notification. Recall that a notification related to a response may be issued in response to receipt of a message sent by a recipient in response to an original message sent on behalf of a sending-user, or in response to non-receipt of a response message prior to expiration of a response window. In some example embodiments, the notification screen 1000 may be automatically displayed for some messages, but displayed in response to a sending-user's interaction for other messages.

Display of the notification screen may be accompanied or preceded by another visual notification, such as a flashing light indicator; an audible notification, such as a ringtone or beep; and/or a tactile notification, such as a vibration caused by a haptic actuator. In some example embodiments, for example where a response message is associated with an elevated notification priority, a sending-user's device may automatically display the sending notification screen 1000. This is one example of an interruption notification. Other examples of interrupting notifications include, but are not limited to, a bright light or pattern of lights having one or more colors, a loud audible tone or pattern of audible tones, or strong vibration or pattern of vibrations notification. In some example embodiments, an interrupting notification may be permitted to override a device's notification settings.

The notification screen 1000 includes a branding area 802, indicating a messaging system or service to which the sending-user interface 1000 provides access; various system indicators, such as clock 803, a mobile carrier signal strength indicator 805, a wireless network strength indicator 807, and a battery level indicator 809; an upload response/send indicator 824, which may be used to initiate uploading a message or response to the messaging system, to indicate upload or download progress, or the like.

The notification screen 1000 also includes an incoming message display area 1002, which may be used to display an incoming message received from a recipient. In cases where the sending user is notified that the recipient has not sent a message within an expected response window, the incoming message display area 1002 may be used to display an indication of non-receipt of an expected response. The incoming message display area 1002 may also be used to display information related to the original message, including message transmission times, some or all of the content of the original message, information about the message recipient, how many times the recipient has failed to respond, or the like.

In one or more example embodiments, the notification screen 1000 includes a response timing area 1012, which displays one or more indicators notifying the sending user how quickly a response to the notification should be sent. In the illustrated example embodiment, response timing area 1012 includes a Now indicator 1004, which indicates that the sending user should send a reply to the response or take some other action promptly; a Soon indicator 1006, which indicates that the sending user has more flexibility in when to send a reply to the response or take some other action; and an Optional indicator 1008, which indicates that the sending user has maximum flexibility regarding if and when to send a reply to the response or take some other action. In some example embodiments, a single indicator may be displayed, for example having different colors, shapes, text, or the like to distinguish between multiple options. In other example embodiments, specific time windows may be suggested or specified by one or more indicators in the response timing area 1012.

In the illustrated example embodiment, the notification screen 1000 also includes a respond within messaging system object 1014, and a Respond Via External Channel Object 1010. A sending-user may select the Respond Within Messaging System Object 1014 to switch to a communications mode screen 900 (FIG. 9A), or an instruction mode screen 950 (FIG. 9B), to compose a reply to the recipient and/or instruct a message handler 100 to transmit a reply on behalf of the sending user. In either case, the reply will be delivered via that messaging system.

Alternatively, the sending-user may select the Respond Via External Channel Object 1010 to switch to reply to the recipient's response via a communication channel other than the messaging system disclosed herein. In some example embodiments, the switch to the external communication channel may be logged by the messaging system, but further communication between the sender and the recipient will take place via a different system, and the messaging system may not participate in any follow-on communications. In at least one example embodiment, a dropdown list of available external communication applications (not illustrated) may be displayed on the notification screen 1000. The sending user may select a preferred external communication channel (e.g., an available communications application). In other example embodiments, the available and/or a default external communication channel may be selected during setup of the application, and/or may be set up automatically based on the sender's and or the recipient's profile information.
in response to the sending user activating the Respond Via External Channel Object 1010, a messaging system application being executed on the sender device 220 may launch a selected or default communications channel available on the sender device 220. The available communications channels may be identified by the sending user during application setup, identified based on a system query issued by the messaging system application, or by using another suitable technique. In at least some example embodiments, other screens may be presented to a sending user, depending on a use context. These screens may include overlapping functionality, including displaying various information, parameters, settings, or the like that may be used to configure the functionality of the messaging system application on the sender device 220, to configure session parameter, parameters and preferences applicable to a specific recipient, a specific group of recipients, particular conversation chains or one or more particular recipients, or the like.

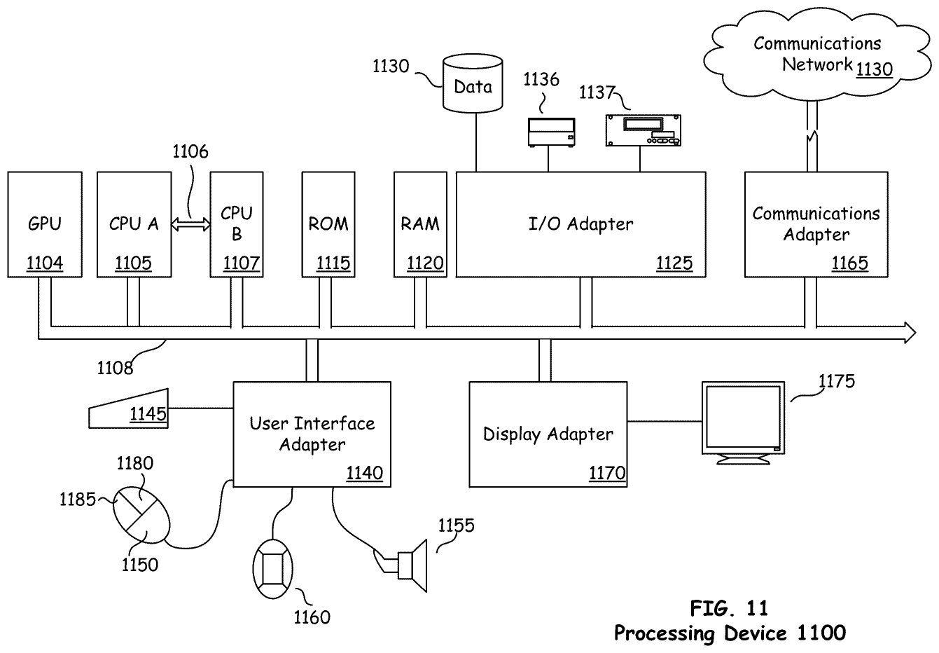

Referring now to FIG. 11, a processing device will be discussed in accordance with various example embodiments. Some or all of the methods and processes described herein can be embodied in or performed by one or more processing systems. An example of such a processing system is discussed with reference to FIG. 11. Processing system 1100 includes one or more central processing units, such as CPU A 1105 and CPU B 1107, which may be conventional microprocessors interconnected with various other units via at least one system bus 1110. CPU A 1105 and CPU B 1107 may be separate cores of an individual, multi-core processor, or individual processors connected via a specialized bus 1111. In some embodiments, CPU A 1105 or CPU B 1107 may be a specialized processor, such as a graphics processor, other co-processor, or the like.

Processing system 1100 includes random access memory (RAM) 1120; read-only memory (ROM) 1115, wherein the ROM 1115 could also be erasable programmable read-only memory (EPROM) or electrically erasable programmable read-only memory (EEPROM); and input/output (I/O) adapter 1125, for connecting peripheral devices such as disk units 1130, optical drive 1136, or tape drive 1137 to system bus 1110; a user interface adapter 1140 for connecting keyboard 1145, mouse 1150, speaker 1155, microphone 1160, or other user interface devices to system bus 1110; communications adapter 1165 for connecting processing system 1100 to an information network such as the Internet or any of various local area networks, wide area networks, telephone networks, or the like; and display adapter 1170 for connecting system bus 1110 to a display device such as monitor 1175. Mouse 1150 has a series of buttons 1180, 1185 and may be used to control a cursor shown on monitor 1175. Monitor 1175 can be used to display a graphical user interface (GUI), implemented by a program of instructions executed by either or both of CPU A 1105 and CPU B 1107.

It will be understood that processing system 1100 may include other suitable data processing systems without departing from the scope of the present disclosure. For example, processing system 1100 may include bulk storage and cache memories, which provide temporary storage of at least some program code in order to reduce the number of times code must be retrieved from bulk storage during execution.

A processing system 1100 may be used to implement an AI model, which may be trained using a labeled dataset to classify a user's typed content as urgent, non-urgent, —meaning each input is paired with the correct output. For example, to train an image classifier, thousands of photos (or more), each tagged with what they contain (e.g., “cat” or “dog”), are provided as training input to the model. The model learns to map inputs to outputs by minimizing its errors over time. This is a powerful training technique, but requires large amounts of labeled data, which can be expensive and time-consuming to produce.

In some example embodiments, the AI model may be trained using reinforcement learning (RL), which refers to a training technique in which a model learns by interacting with an environment and receiving feedback in the form of rewards or penalties. Rather than being told the “right answer,” the model discovers effective strategies for determining “correct” answers through trial and error. This is how AI systems like AlphaGo mastered chess and Go. A variant called Reinforcement Learning from Human Feedback (RLHF) may be used to fine-tune language models. In RLHF human raters score an AI Model's outputs, and those scores guide further training toward more helpful and accurate responses.

Other example embodiments employ Transfer Learning & Fine-Tuning instead of training the model from scratch. In Transfer Learning and Fine-Tuning, a large pre-trained model (one already trained on a broad dataset) is adapted to a specific task using a smaller, task-specific dataset. This is extremely common in modern AI. In yet other example embodiments, a combination of these approaches may be used.

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

One or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information.

As applicable, one or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition-requires “artificial” intelligence—i.e., machine/non-human intelligence.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method comprising:
transmitting, by or on behalf of a first user of a messaging system, via a messaging system including on one or more processing devices, a message addressed to a second user of the messaging system;
determining a response status of a response message, the response status indicating receipt or non-receipt of the response message via the messaging system;
setting a notification priority based, at least in part, on the response status, wherein a first response status associated with non-receipt of the response message is assigned a first notification priority, and a second response status associated with receipt of the response message is assigned a second notification priority as indicated by information included in the response message; and
activating a notification to the first user via the messaging system based on the notification priority.

2. The method of claim 1, further comprising:
scheduling, by or on behalf of the first user, automated transmission of one or more messages to the second user at one or more future times;
providing the second user with a schedule indicating when the one or more messages are scheduled to be transmitted; and
automatically transmitting, by the messaging system, the one or more messages in accordance with the schedule.

3. The method of claim 1, further comprising:
opening, by the messaging system, a response window, the response window defining a period for the second user to transmit the response message.

4. The method of claim 3, further comprising:
in response to non-receipt of the response message by the messaging system before expiration of the response window, the messaging system sets the first notification priority to high.

5. The method of claim 3, further comprising:
in response to the messaging system receiving the response message before expiration of the response window, the messaging system sets the second notification priority to a value determined by the information included in the response message.

6. The method of claim 1, further comprising:
presenting to the first user via a graphical user interface (GUI) an option to respond to the notification by switching to an external communication channel.

7. The method of claim 1, further comprising:
receiving, from the second user, second-user input authorizing the first user to transmit and schedule future message transmissions via the messaging system; and
transmitting the message from the first user to the second user in accordance with the second-user input.

8. The method of claim 7, further comprising:
receiving, from the second user, third-user input revoking permission to schedule the future message transmissions via the messaging system.

9. The method of claim 1, further comprising:
receiving, from the second user, fourth-user input granting permission to use AI for messaging interactions.

10. The method of claim 9, further comprising:
receiving, from the second user, fifth-user input revoking permission to use AI for the messaging interactions.

11. The method of claim 1, further comprising:
wherein the second notification priority, as indicated by the information included in the response message, includes second-user input specifying a level of urgency.

12. The method of claim 1, further comprising:
creating, by the messaging system, an auditable record of communications to and from the second user, including response messages assigned notification priorities above a given threshold.

13. A messaging system comprising:
a first program of instructions configured to provide a first-user interface to the messaging system, the first program of instructions configured to be executed on a first endpoint computing device; and
a second program of instructions configured to provide a second user interface to the messaging system, the first program of instructions configured to be executed on a second endpoint computing device;
the first program of instructions further configured to:
receive, via the first-user interface, transmission instructions associated with transmitting a message to the second user interface;
determine a response status of a response message, the response status indicating at least one of non-receipt of a response message originating from the second user interface or receipt of the response message originating from the second user interface;
set a notification priority based at least in part on the response status, wherein a first response status is associated with the non-receipt of the response message, and is assigned a first notification priority, and a second response status associated with the receipt of the response message is assigned a second notification priority as indicated by information included in the response message; and
activate a notification based on the notification priority.

14. The messaging system of claim 13, further comprising:
a message server including a processor and associated memory, the message server communicatively coupled to the first endpoint computing device and the second endpoint computing device;
the message server configured to:
receive the transmission instructions from the first-user interface; and
transmit the message to the second endpoint computing device in accordance with the transmission instructions.

15. The messaging system of claim 14, wherein the message server is further configured to:
log messages transmitted to the second endpoint computing device by, or on behalf of, the first endpoint computing device; and
log response statuses associated with the messages transmitted to the second endpoint computing device by, or on behalf of, the first endpoint computing device.

16. The messaging system of claim 14, wherein the transmission instructions include:
scheduling information associated with future transmission of one or more additional messages; and
content identification information associated with each of the one or more additional messages.

17. The messaging system of claim 16, wherein the second program of instructions is further configured to:
receive at least one message transmitted to the second endpoint computing device in accordance with the transmission instructions;
display the at least one message on the second endpoint computing device;
receive user input specifying urgency information to be included in a particular response message associated with the at least one message; and
generate the particular response message to include the urgency information.

18. The messaging system of claim 13, wherein the transmission instructions include:
at least one of an instance of the message, or content identification information associated with the message, the content identification information including a message template identifier.

19. The messaging system of claim 13, wherein the first program of instructions and the second program of instructions are differently configured instances of a same program of instructions.

20. The messaging system of claim 13, wherein the first program of instructions is further configured to transmit the message to the second user interface in accordance with the transmission instructions.

21. The messaging system of claim 13, wherein the first program of instructions is further configured to:
open a response window, the response window defining a period during which a response message is anticipated.

22. The messaging system of claim 21, wherein the first program of instructions is further configured to:
activate an interruptive notification on the first endpoint computing device in response to non-receipt of the response message before expiration of the response window; and
activate one of an interruptive or a non-interruptive notification in response to receipt of the response message before expiration of the response window.

23. An endpoint computing device comprising:
memory storing a program of instructions;
a processor coupled to the memory, the processor configured to execute the program of instructions to cause the computing endpoint device to:
generate a graphical user interface (GUI) of a messaging system;
receive from a first endpoint user of the messaging system, via the GUI, instructions to transmit one or more messages to a second endpoint user according to a schedule;
determine whether a response message associated with a first message has been received before expiration of a first response window; and
assign a notification priority associated with the response message based, at least in part on, whether the response message associated with the first message has been received before expiration of the first response window, wherein
the notification priority is set to an elevated priority level assigned in response to non-receipt of a response message before expiration of the first response window, and
the notification priority is set to a variable priority level indicated by information included in the response message in response to receiving the response message within the first response window; and
initiate one of a plurality of different types of notifications to the first endpoint user based on the notification priority.
